(19) United States
(12) Patent Application Publication
(10) Pub. No.: US 2024/0283830 A1
(43) Pub. Date: Aug. 22, 2024

(54) XR MEDIA CHANNELS FOR IMMERSIVE REALTIME COMMUNICATION

(71) Applicant: Meta Platforms, Inc., Menlo Park, CA (US)

(72) Inventors: Shreyas Narendra Basarge, Mountain View, CA (US); Ankush Bagotra, Milpitas, CA (US); Yuchen Huang, Sunnyvale, CA (US); Yuan Sui, Kirkland, WA (US); Kevin Stichter, San Francisco, CA (US); Xishuo Liu, Palo Alto, CA (US); Zelei Sun, Kirkland, WA (US); Alexander Lin, Sunnyvale, CA (US)

(21) Appl. No.: 18/095,453

(22) Filed: Jan. 10, 2023

(51) Int. Cl. H04L 65/1089; H04L 65/1083

(52) U.S. Cl. CPC H04L 65/1089; H04L 65/1086

(57) ABSTRACT

Systems, methods, and non-transitory computer-readable media can be configured to perform operations comprising determining capabilities associated with a plurality of devices in a communication session, determining one or more media channels for transmission of media between the plurality of devices based on the capabilities, and facilitating the transmission of media between the plurality of devices via the one or more media channels.

### FIELD OF THE INVENTION

The present technology relates to digital media. More particularly, the present technology relates to extended media channels to support various media types.

### BACKGROUND

Today, people often utilize computing devices (or systems) for a wide variety of purposes. For example, users can utilize computing devices to access a social networking system or other type of content or communication platform. The users can utilize the computing devices to interact with one another, share content items, and view content items via the platform. In some instances, a user may post content to a communication platform. Content posted to the communication platform may include text content items and media content items, such as audio, images, and videos. The posted content may be published to the communication platform and accessed by other users.

### SUMMARY

Various embodiments of the present technology can include systems, methods, and non-transitory computer readable media configured to perform operations comprising determining capabilities associated with a plurality of devices in a communication session, determining one or more media channels for transmission of media between the plurality of devices based on the capabilities, and facilitating the transmission of media between the plurality of devices via the one or more media channels.

In an embodiment, the operations further comprise determining additional capabilities associated with an additional device that has joined the communication session, and determining an additional media channel for the transmission of media between the plurality of devices and the additional device based on the capabilities and the additional capabilities, wherein the transmission of the media between the plurality of devices and the additional device is via the one or more media channels and the additional media channel.

In an embodiment, the operations further comprise determining a device of the plurality of devices has left the communication session, and removing a media channel of the one or more media channels based on the device.

In an embodiment, each media channel of the one or more media channels is associated with a respective media content type.

In an embodiment, the operations further comprise allocating bandwidth for the one or more media channels based on a minimum bandwidth threshold.

In an embodiment, the transmission of media is based on a packet format, and wherein a packet in the transmission of media includes a frame for each media content type associated with the one or more media channels.

In an embodiment, the capabilities associated with the plurality of devices includes device capabilities and software capabilities.

In an embodiment, the one or more media channels are determined based selections by users associated with the plurality of devices.

In an embodiment, the one or more media channels are multiplexed.

In an embodiment, the media is encrypted.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system including an extended media module, according to an embodiment of the present technology.

FIG. 2 illustrates an example functional block diagram, according to an embodiment of the present technology.

FIG. 3 illustrates an example functional block diagram, according to an embodiment of the present technology.

FIGS. 4A-4B illustrate example timing diagrams, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

Today, people often utilize computing devices (or systems) for a wide variety of purposes. For example, users can utilize computing devices to access a social networking system or other type of content or communication platform. The users can utilize the computing devices to interact with one another, share content items, and view content items via the platform. In some instances, a user may post content to a communication platform. Content posted to the communication platform may include text content items and media content items, such as audio, images, and videos. The posted content may be published to the communication platform and accessed by other users.

One way for users to interact with each other through a communication platform is by sharing content items through the communication platform. For example, a first user can create a content item and publish it to a communication platform. The first user can share the content item with a second user. The second user can access the content item through the communication platform. The second user can respond to the content item, for example, by posting a comment. The first user can access the comment through the communication platform. As illustrated in this example, when users interact with each other through a communication platform by sharing content items, the interaction does not occur in real time. As users may also want to interact with each other through a communication platform in real time, it would be advantageous for the communication platform to also provide real time communication through the communication platform. However, various devices that the users use to access the communication platform have different capabilities. Because the various devices have different capabilities, some devices cannot support some forms of real time communication. These technological challenges associated with failure to support various forms of real time communication are exacerbated as the communication platform introduces new forms of real time communication and as differences in capabilities of the various devices continue to grow. Thus, conventional approaches to real time communication face various technological challenges.

An improved approach rooted in computer technology overcomes the foregoing and other disadvantages associated with conventional approaches specifically arising in the realm of computer technology. In various embodiments, the present technology provides for media channels to support media content types. A server system (e.g., multi way server, communication platform) can provide a communication session to users. The communication session can involve real time communication between the users through one or more media content types (e.g., video, audio, 3D video, virtual reality, augmented reality, three-dimensional avatar, depth and transparency, neural embeddings). The server system can determine capabilities of devices the users are using for the communication session. Based on the capabilities of the devices the users are using, the server system can determine media content types the devices can support during the communication session. Based on the media content types the devices can support, the server system can determine media channels for the communication session. The media channels can correspond with the media content types that the devices support. As additional users join the communication session, the server system can determine capabilities of additional devices the additional users are using for the communication session. Based on the capabilities of the additional devices the additional users are using for the communication session, and the media the additional devices can support, the server system can determine additional media channels, if necessary, for the communication session. As users leave the communication session, the server system can determine capabilities of remaining devices that the remaining users are using for the communication session. Based on the capabilities of the remaining devices the remaining users are using for the communication session, and the media the remaining devices can support, the server system can determine whether to remove media channels from the communication session and which media channels to remove from the communication session.

As just one example, a server system can provide a communication session to a first user and a second user. The first user and the second user can communicate with each other in real time through the server system during the communication session. The server system can determine capabilities of a first device the first user is using for the communication session. For example, the server system can determine the first device can support communication through video and 3D avatars. The server system can determine capabilities of a second device the second user is using for the communication session. For example, the server system can determine the second device can support video. Based on the capabilities of the first device and the capabilities of the second device, the server system can determine a media channel for the communication session. In this example, the server system can determine a video media channel for the communication session based on a determination that the first device and the second device both support video. The first device and the second device can communicate with each other in real time using video transmitted through the video media channel. Continuing this example, a third user can join the communication session. The server system can determine capabilities of a third device the third user is using for the communication session. For example, the server system can determine the third device can support video and 3D avatars. Based on the capabilities of the third device, as well as the capabilities of the first device and the capabilities of the second device, the server system can determine an additional media channel for the communication session. In this example, the server system can determine a 3D avatar media channel for communication between the first device and the third device and the video media channel for communication between the first device, the second device, and the third device, for the communication session. Continuing this example, the third user can leave the communication session. The server system can determine the 3D avatar media channel is no longer needed for communication between the first device and the second device based on the capabilities of the first device and the capabilities of the second device. The server system can remove the 3D avatar media channel from the communication session. More details relating to the present technology are provided below.

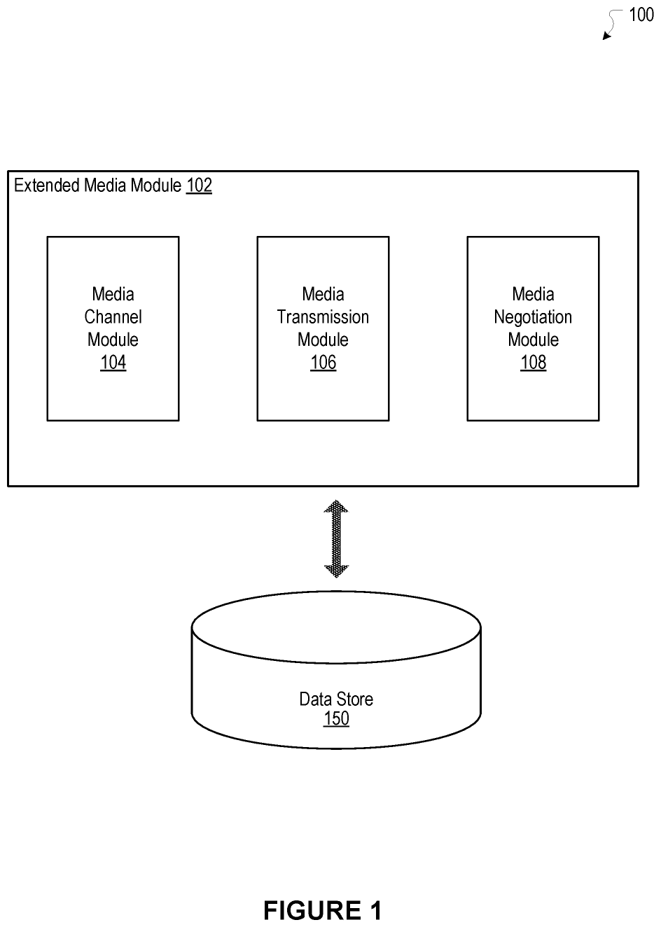

FIG. 1 illustrates an example system 100 including an extended media module 102, according to an embodiment of the present technology. As shown in the example of FIG. 1, the extended media module 102 can include a media channel module 104, a media transmission module 106, and a media negotiation module 108. In some instances, the example system 100 can include at least one data store 150 in communication with the extended media module 102. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the AR media channel module 104, the media transmission module 106, and the media negotiation module 108 can be implemented in any suitable combinations. While the extended media module 102 is sometimes herein discussed in connection with a social networking system for purposes of illustration, the extended media module 102 of the present technology can be used in or for any other type of content or communication platform that can support content delivery, such as a content delivery platform, a communication platform, etc. For example, the extended media module 102 can be implemented in a suitable server system, such as a content delivery server.

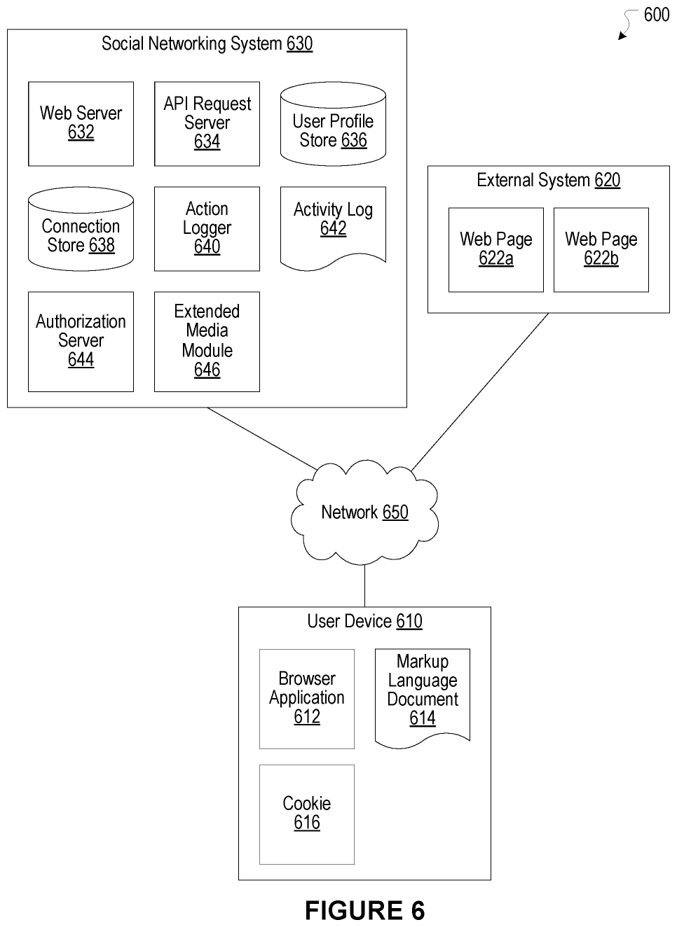

In various embodiments, the extended media module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some instances, the extended media module 102 can be, in part or in whole, implemented as software running on one or more computing devices or systems, such as on a server system or a client computing device. In some instances, the extended media module 102 can be, in part or in whole, implemented within or configured to operate in conjunction with or be integrated with a social networking system (or service), such as a social networking system 630 of FIG. 6. Likewise, in some instances, the extended media module 102 can be, in part or in whole, implemented within or configured to operate in conjunction with or be integrated with a client computing device, such as a user device 610 of FIG. 6. For example, the extended media module 102 can be implemented as or within a dedicated application (e.g., app), a program, or an applet running on a user computing device or client computing system. The application incorporating or implementing instructions for performing functionality of the extended media module 102 can be created by a developer. The application can be provided to or maintained in a repository. In some instances, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

The extended media module 102 can be configured to communicate and/or operate with the data store 150, as shown in the example system 100. The data store 150 can be configured to store and maintain various types of data. In some implementations, the data store 150 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 150 can store information that is utilized by the extended media module 102. For example, the data store 150 can store information associated with user preferences, device capabilities, and media content items. It is contemplated that there can be many variations or other possibilities.

In various embodiments, the media channel module 104 can support and facilitate provision of media channels for a communication session. A media channel can facilitate communication between entities, such as between devices and servers, between servers, or between devices. The media channel can correspond with a media content type. The media channel can facilitate communication of media of the corresponding media content type between the entities. Media channels can provide for flexibility by facilitating communication between entities that support the same media content types. A media channel of a media content type can facilitate communication between entities that support the media content type. Entities that do not support the media content type can be excluded from the media channel. Thus, only entities that support a media content type corresponding with a media channel are in communication with each other through the media channel. In some cases, entities can support multiple same media content types. In such cases, a media channel can facilitate communication between entities based on a selected media content type. For example, a server can facilitate a communication session between a first user, a second user, and a third user. The first user can use a first device that supports, for example, video and 3D video. The second user can use a second device that supports, for example, video. The third user can use a third device that supports, for example, video, 3D video, and virtual reality. Media channels can facilitate communication between the devices and the server based on the media content type supported by the devices. A first media channel corresponding with video can facilitate communication between the first device, the second device, the third device, and the server. A second media channel corresponding with 3D video can facilitate communication between the first device, the third device, and the server. In this example, the first user or the third user may select to communicate with video instead of 3D video. The second media channel corresponding with 3D video can be removed based on the selection to communicate with video from the first user or the third user. Many variations are possible.

In various embodiments, the media transmission module 106 can support and facilitate transmission of media through media channels for a communication session. Media of a media content type can be transmitted through a media channel corresponding with the media content type. A server can facilitate transmission of the media through the media channel. The media can be transmitted by a first device to the server through the media channel. The server can forward the media to a second device through the media channel. In some cases, communication between devices can involve a set of media channels corresponding with a set of media content types. In these cases, the set of media channels can be multiplexed together to generate a multiplexed media channel. Media of the set of media content types can be received through the multiplexed media channel, for example, by a server, and be separated to media corresponding with separate media content types and corresponding separate media channels. The media corresponding with the separate media content types can be forwarded, for example, by the server to devices through the corresponding separate media channels. In some cases, some of the separate media channels can be multiplexed together as subsets of the set of media channels. The media corresponding with subsets of media content types corresponding with the subsets of media channels can be forwarded, for example, by the server to devices through the subsets of media channels. For example, a server can facilitate a communication session between a first user, a second user, and a third user. The first user can use a first device that supports, for example, video and 3D avatars. The second user can use a second device that supports, for example, video. The third user can use a third device that supports, for example, video and 3D avatars. The first user and the third user may communicate with each other based on 3D avatars. The first user and the third user may communicate with the second user based on video. The first device can transmit media including video and 3D avatars through a multiplexed media channel that includes a first media channel for video and a second media channel for 3D avatars to the server. The server can separate the media received through the multiplexed media channel. The server can forward the media including video through a first separate media channel for video to the second device. The server can forward the media including 3D avatars through a second separate media channel for 3D avatars to the third device.

The media transmission module 106 can support and facilitate transmission of media through media channels for a communication session based on a packet format that supports media for one or more media content types. In cases where transmission of media involves one media content type, a packet in accordance with the packet format can include data for a frame of media of the one media content type. The packet can include a header that indicates various information associated with the frame of media. The information can include, for example, the media content type of the frame of media, timing information associated with the frame of media, and dependencies associated with the frame of media. In cases where transmission of media involves multiple media content types, a packet in accordance with the packet format can include data for a frame of media for each media content type being transmitted. The media for each media content type being transmitted can be synchronized by including data for a frame of the media for each media content type in a packet. The packet can include a header that indicates various information associated with the frames of media. The information can include, for example, the media content types of the frames of media, timing information associated with the frames of media, dependencies associated with the frames of media, and offsets within the packet where data for the frames of media are located. For example, a device in a communication session can transmit media including video and 3D video through a multiplexed media channel to a server. The device can transmit the media in a packet format. Each packet can include data for a frame of video and data for a frame of 3D video. Each packet can include a header that indicates, for example, the packet includes video and 3D video and offsets where the data for the frame of video and the data for the frame of 3D video are located in the packet.

The media transmission module 106 can facilitate bandwidth allocation for transmission of media through media channels for a communication session. In general, bandwidth for transmission of media can vary depending on network conditions. Media of various media content types can be downscaled in accordance with low bandwidth or upscaled in accordance with high bandwidth. For example, video is a media content type that can be downscaled or upscaled in accordance with available bandwidth. In some cases, media of some media content types require bandwidth that satisfies a minimum bandwidth threshold in order to render correctly in real time. For example, 3D video that use a 3D mesh can have a minimum bandwidth threshold. The media transmission module 106 can facilitate bandwidth allocation for transmission of media based on media content types of the media. For media of a media content type associated with a minimum bandwidth threshold, bandwidth can be allocated such that at least the minimum bandwidth threshold is met. For media of a media content type that can be downscaled or upscaled in accordance with available bandwidth, bandwidth can be allocated proportionally. For example, a communication session can involve a first media channel for video and a second media channel for 3D video. Based on the media content type associated with the first media channel and the second media channel, bandwidth can be allocated between the first media channel and the second media channel. Bandwidth can be allocated for the second media channel such that a minimum bandwidth threshold associated with 3D video is satisfied. Available bandwidth beyond the bandwidth allocated for the second media channel can be allocated such that bandwidth allocated between the first media channel and the second media channel are proportional. In other words, available bandwidth can be allocated evenly between the first media channel and the second media channel as long as the available bandwidth allocated to the second media channel satisfies the minimum bandwidth threshold associated with 3D video.

The media transmission module 106 can generate media for transmission through a media channel for a communication session. In some cases, media of a media content type can be generated based on media of another media content type to facilitate bandwidth allocation for transmission of media through media channels for a communication session. For example, video can be generated based on 3D video. The media transmission module 106 can generate first media of a first media content type based on second media of a second media content type and facilitate transmission of both the first media and the second media through respective media channels. It should be understood that the first media of the first media content type may not be generated where the second media of the second media type is encrypted without means to decrypt the second media. For example, a server can facilitate a communication session between a first user, a second user, and a third user. The first user can use a first device that supports, for example, video and 3D video. The second user can use a second device that supports, for example, video. The third user can use a third device that supports, for example, video and 3D video. The first user and the third user may communicate with each other based on 3D video. The first user and the third user may communicate with the second user based on video. The first device can transmit media including 3D video through a first media channel for 3D video to the server. The server can generate video based on the 3D video. The server can transmit media including the generated video through a second media channel for video to the second device. The server can forward media including the 3D video through the first media channel to the third device. Many variations are possible.

In various embodiments, the media negotiation module 108 can support and facilitate negotiation, and renegotiation, of media channels for a communication session. The media negotiation module 108 can determine the media channels for the communication session based on capabilities of devices in the communication session. The capabilities can include, for example, device capabilities (e.g., processor capabilities, memory capabilities, sensor capabilities, camera capabilities) and software capabilities (e.g., codecs, installed applications, application settings). Based on the capabilities, the media negotiation module 108 can determine media content types the devices in the communication session can support. The media channels can be determined based on the media content types the devices in the communication session can support. The media channels can be negotiated so that the devices involved in the communication session are provided with media in accordance with the capabilities of the devices and any selections for desired media made by users of the devices. The media channels can be negotiated when the communication session begins. The media channels can be renegotiated as devices join or leave the communication session. The media channels can be renegotiated as the users of the devices change their selections for desired media. For example, a server can facilitate a communication session between a first user and a second user. The first user can use a first device that supports, for example, video and 3D video. The second user can use a second device that supports, for example, video. The server can determine capabilities of the first device and capabilities of the second device. Based on the capabilities of the first device and the capabilities of the second device, a video media channel can be negotiated for the communication session. The server can provide the communication session with the video media channel. In this example, a third user can join the communication session. The third user can use a third device that supports, for example, video and 3D video. The server can determine capabilities of the third device and, based on the capabilities of the third device, determine a 3D video media channel is appropriate for the communication session with respect to the first user and the third user. Based on the capabilities of the first device, the capabilities of the second device, and the capabilities of the third device, the media channels for the communication session can be renegotiated. In this example, the first user and the third user can make selections to use 3D video over video. The server can provide the communication session with the video media channel and the 3D video media channel based on the renegotiation. During the communication session, the third user can make a selection to use video instead of 3D video. Based on the selection by the third user, the media channels for the communication can be renegotiated. In this example, based on the selection by the third user, the 3D video media channel can be removed from the communication session. Many variations are possible.

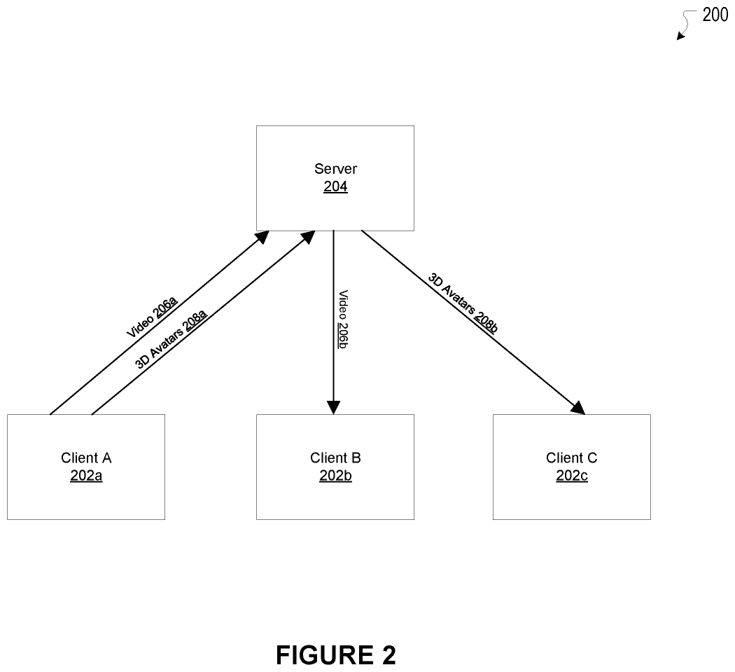

FIG. 2 illustrates an example functional block diagram 200, according to an embodiment of the present technology. The example functional block diagram 200 illustrates an example process that can be performed or facilitated by the extended media module 102 of FIG. 1. It should be understood that there can be additional, fewer, or alternative steps performed in similar or alternative orders, or in parallel, based on the various features and embodiments discussed herein unless otherwise stated. All examples herein are provided for illustrative purposes, and there can be many variations and other possibilities.

The example functional block diagram 200 illustrates a communication session involving client A 202a, client B 202b, client C 202c, and server 204. In this example, client A 202a can support video and 3D avatars. Client B 202b can support video. Client C 202c can support video and 3D avatars. Server 204 can provide media channels for the communication session based on media client A 202a, client B 202b, and client C 202c can support. As illustrated in this example, client A 202a can transmit video 206a to server 204 through a video media channel. Client A 202a can transmit 3D avatars 208a to server 204 through a 3D avatars media channel. Server 204 can transmit video 206b, which is the video 206a received from client A 202a, to client B 202b through the video media channel. Server 204 can transmit 3D avatars 208b, which is the 3D avatars 208a received from client A 202a, to client C 202c through the 3D avatars media channel. Many variations are possible.

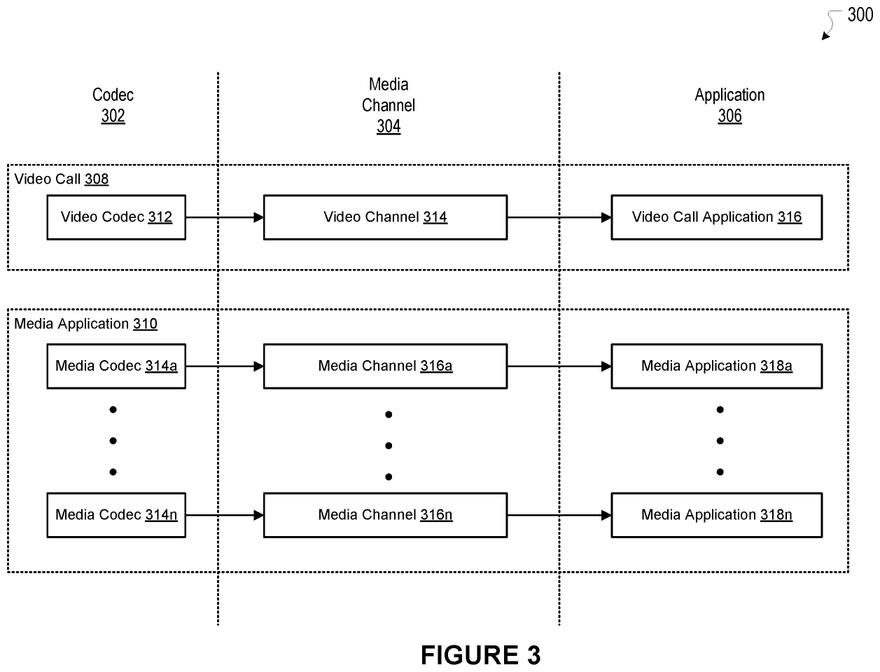

FIG. 3 illustrates an example functional block diagram 300, according to an embodiment of the present technology. The example functional block diagram 300 illustrates example media channels that can be facilitated by the extended media module 102 of FIG. 1. It should be understood that there can be additional, fewer, or alternative steps performed in similar or alternative orders, or in parallel, based on the various features and embodiments discussed herein unless otherwise stated. All examples herein are provided for illustrative purposes, and there can be many variations and other possibilities.

The example functional block diagram 300 illustrates relationships between codecs 302, media channels 304, and applications 306 in a communication session. As illustrated in this example, the communication session can involve a video call 308. Video can be generated based on a video codec 312. The video generated based on the video codec 312 can be transmitted through a video channel 314. The video transmitted through the video channel 314 can be received and processed by a video call application 316. For example, the video can be generated based on the H.265 video codec, transmitted through a default video media channel, and processed by a default video calling application. As illustrated in this example, the communication session can involve other media associated with media applications 310. The media can be generated based on media codecs 314a, 314n. The media generated based on media codecs 314a, 314n can be transmitted through media channels 316a, 316n. The media transmitted through the media channels 316a, 316n can be received and processed by media applications 318a, 318n. For example, media can be generated based on a YUVA codec and a CV codec and transmitted through media channels. The media generated based on the YUVA codec can be processed by an augmented reality application. The media generated based on the CV codec can be processed by a 3D avatar application. Many variations are possible.

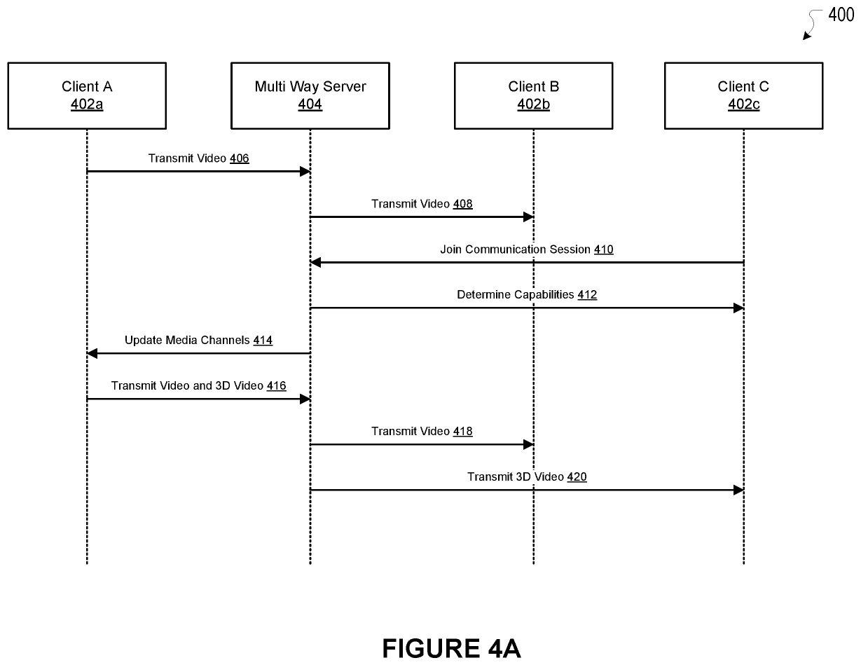

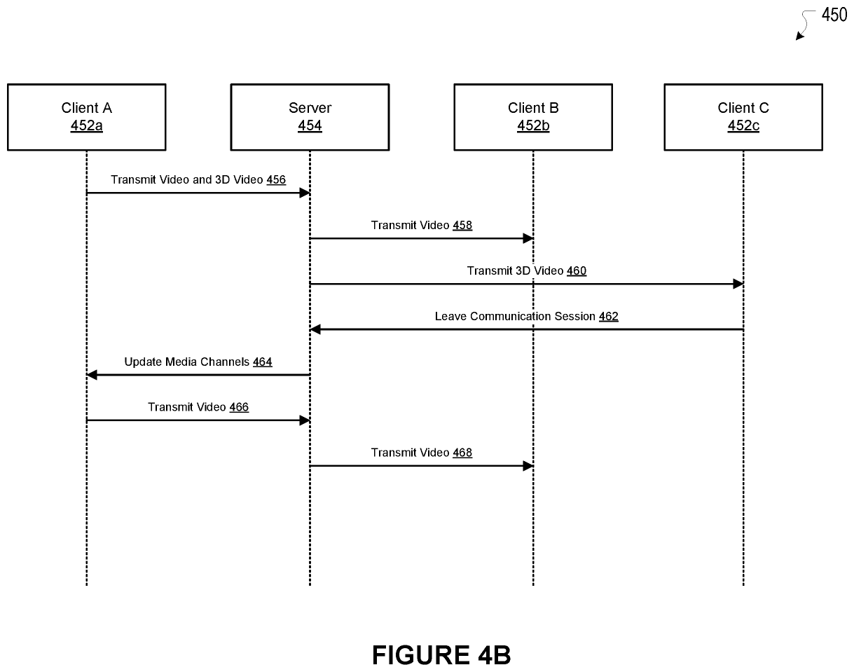

FIGS. 4A-4B illustrate example timing diagrams, according to an embodiment of the present technology. The example timing diagrams can be associated with one or more functionalities performed by the extended media module 102 of FIG. 1. It should be understood that there can be additional, fewer, or alternative steps performed in similar or alternative orders, or in parallel, based on the various features and embodiments discussed herein unless otherwise stated. All examples herein are provided for illustrative purposes, and there can be many variations and other possibilities.

FIG. 4A illustrates an example timing diagram 400, according to an embodiment of the present technology. The timing diagram 400 illustrates client A 402a, client B 402b, client C 402c, and multi way server 404. In this example, client A 402a can support video and 3D video. Client B 402b can support video. Client C 402c can support video and 3D video. Multi way server 404 initially provides a communication session between client A 402a and client B 402b. At step 406, client A 402a transmits video through a video media channel to multi way server 404. At step 408, multi way server 404 transmits video from client A 402a to client B 402b through the video media channel. At step 410, client C 402c joins the communication session through multi way server 404. At step 412, multi way server 404 determines capabilities of client C 402c. Based on the capabilities of client C 402c, multi way server 404 can provide a 3D video media channel for communication between client A 402a and client C 402c. At step 414, multi way server 404 updates client A 402a of the media channels. At step 416, client A 402a transmits video and 3D video through the video media channel and the 3D video media channel to multi way server 404. At step 418, multi way server 404 transmits video from client A 402a to client B 402b through the video media channel. At step 420, multi way server transmits 3D video from client A 402a to client C 402c through the 3D video media channel. Many variations are possible.

FIG. 4B illustrates an example sequence 450, according to an embodiment of the present technology. The timing diagram 450 400 illustrates client A 452a, client B 452b, client C 452c, and server 454. In this example, client A 452a can support video and 3D video. Client B 452b can support video. Client C 452c can support video and 3D video. Server 454 provides a communication session between client A 452a, client B 452b, and client C 452c. At step 456, client A 452a transmits video and 3D video through a video media channel and a 3D video media channel to server 454. At step 458, server 454 transmits video from client A 452a to client B 452b through the video media channel. At step 460, server 454 transmits 3D video from client A 452a to client C 452c through the 3D video media channel. At step 462, client C 402c leaves the communication session. At step 464, server updates media channels for the communication session based on client C 402c leaving the communication session. At step 466, client A 452a transmits video to server 454 through the video media channel. At step 468, server 454 transmits video received from client A 452a to client B 452b through the video media channel. Many variations are possible.

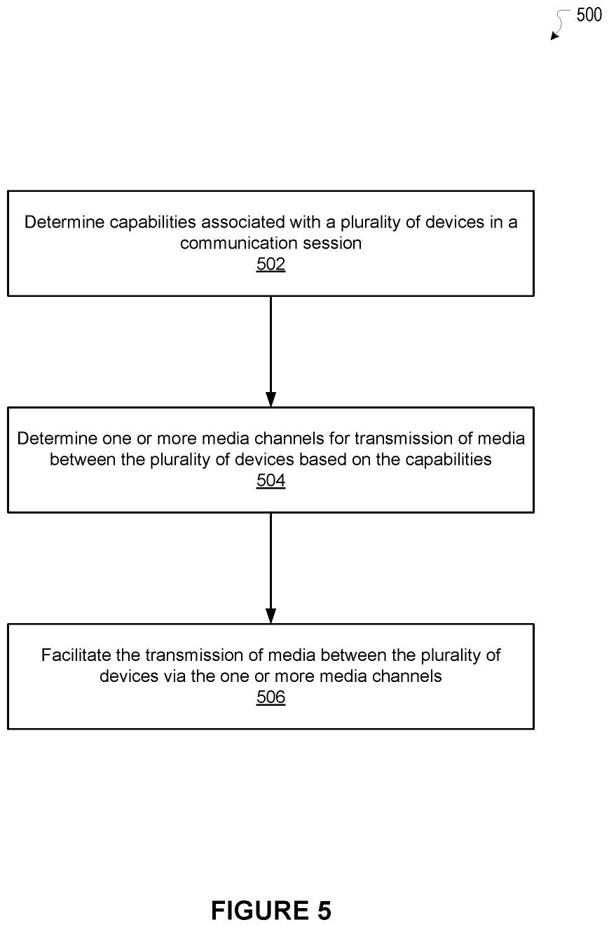

FIG. 5 illustrates an example method 500, according to an embodiment of the present technology. It should be understood that there can be additional, fewer, or alternative steps performed in similar or alternative orders, or in parallel, based on the various features and embodiments discussed herein unless otherwise stated. At block 502, the example method 500 determines capabilities associated with a plurality of devices in a communication session. At block 504, the example method 500 determines one or more media channels for transmission of media between the plurality of devices based on the capabilities. At block 506, the example method 500 facilitates the transmission of media between the plurality of devices via the one or more media channels.

It is contemplated that there can be many other uses, applications, and/or variations associated with the various embodiments of the present technology. For example, in some cases, a user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, according to an embodiment of the present technology. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include an extended media module 646. The extended media module 646 can be implemented with the extended media module 102, as discussed in more detail herein. In various embodiments, some or all functionality of the extended media module 102 can be additionally or alternatively implemented by the user device 610. It should be appreciated that there can be many variations or other possibilities.

### Hardware Implementation

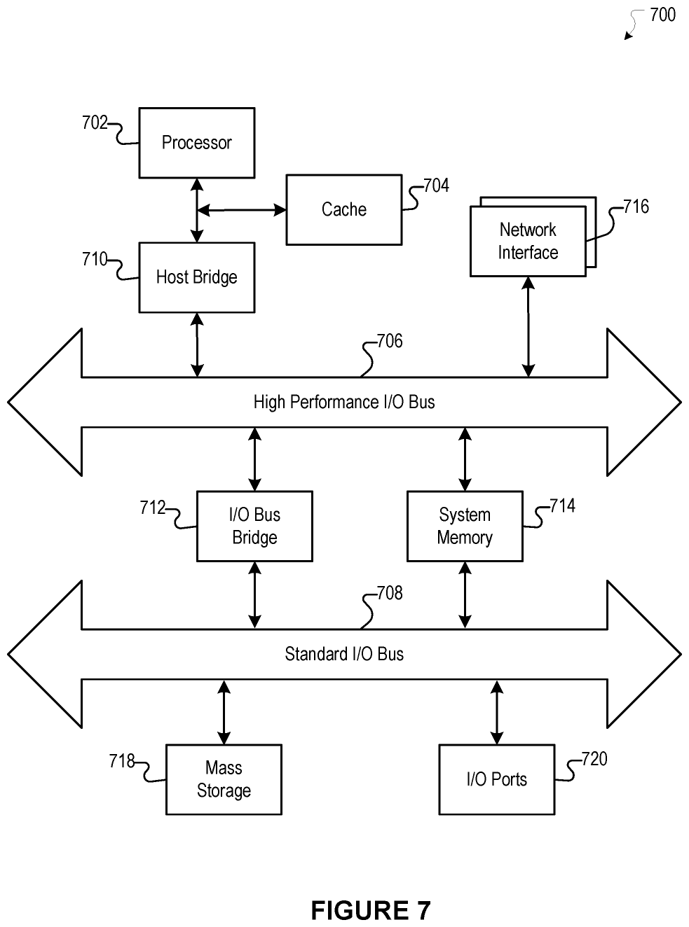

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the ×86-compatible processors manufactured by Intel Corporation of Santa Clara, California, and the ×86-compatible processors manufactured by Advanced Micro Devices (AMD), Inc., of Sunnyvale, California, as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the technology can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the present technology. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, capabilities associated with a plurality of devices in a communication session;
determining, by the computing system, a plurality of media channels for transmission of media between the plurality of devices based on the capabilities; and
facilitating, by the computing system, the transmission of media between the plurality of devices via the plurality of media channels,
wherein each media channel of the plurality of media channels is associated with a respective media content type.

2. The computer-implemented method of claim 1, further comprising: determining, by the computing system, additional capabilities associated with an additional device that has joined the communication session; and
determining, by the computing system, an additional media channel for the transmission of media between the plurality of devices and the additional device based on the capabilities and the additional capabilities, wherein the transmission of the media between the plurality of devices and the additional device is via the plurality of media channels and the additional media channel.

3. The computer-implemented method of claim 1, further comprising:
determining, by the computing system, a device of the plurality of devices has left the communication session; and
removing, by the computing system, a media channel of the plurality of media channels based on the device.

4. (canceled)

5. The computer-implemented method of claim 1, further comprising: allocating, by the computing system, bandwidth for the plurality of media channels based on a minimum bandwidth threshold.

6. The computer-implemented method of claim 1, wherein the transmission of media is based on a packet format that supports media for a plurality of media content types, and wherein a packet in the transmission of media includes a frame for each media content type associated with the plurality of media channels.

7. The computer-implemented method of claim 1, wherein the capabilities associated with the plurality of devices includes device capabilities and software capabilities.

8. The computer-implemented method of claim 1, wherein the plurality of media channels are determined based selections by users associated with the plurality of devices.

9. The computer-implemented method of claim 1, wherein the plurality of media channels are multiplexed.

10. The computer-implemented method of claim 1, wherein the media is encrypted.

11. A system comprising:
at least one processor; and
a memory storing instructions that, when executed by the at least one processor, cause the system to perform operations comprising:
determining capabilities associated with a plurality of devices in a communication session;
determining a plurality of media channels for transmission of media between the plurality of devices based on the capabilities; and
facilitating the transmission of media between the plurality of devices via the plurality of media channels,
wherein each media channel of the plurality of media channels is associated with a respective media content type.

12. The system of claim 11, the operations further comprising:
determining additional capabilities associated with an additional device that has joined the communication session; and
determining an additional media channel for the transmission of media between the plurality of devices and the additional device based on the capabilities and the additional capabilities, wherein the transmission of the media between the plurality of devices and the additional device is via the plurality of media channels and the additional media channel.

13. The system of claim 11, the operations further comprising:
determining a device of the plurality of devices has left the communication session; and
removing a media channel of the plurality of media channels based on the device.

14. (canceled)

15. The system of claim 11, the operations further comprising:
allocating bandwidth for the plurality of media channels based on a minimum bandwidth threshold.

16. A non-transitory computer-readable storage medium including instructions that, when executed by at least one processor of a computing system, cause the computing system to perform operations comprising:
determining capabilities associated with a plurality of devices in a communication session;
determining a plurality of media channels for transmission of media between the plurality of devices based on the capabilities; and
facilitating the transmission of media between the plurality of devices via the plurality of media channels,
wherein each media channel of the one or more media channels is associated with a respective media content type.

17. The non-transitory computer-readable storage medium of claim 16, the operations further comprising:
determining additional capabilities associated with an additional device that has joined the communication session; and
determining an additional media channel for the transmission of media between the plurality of devices and the additional device based on the capabilities and the additional capabilities, wherein the transmission of the media between the plurality of devices and the additional device is via the plurality of media channels and the additional media channel.

18. The non-transitory computer-readable storage medium of claim 16, the operations further comprising:
determining a device of the plurality of devices has left the communication session; and
removing a media channel of the plurality of media channels based on the device.

19. (canceled)

20. The non-transitory computer-readable storage medium of claim 16, the operations further comprising:
allocating bandwidth for the plurality of media channels based on a minimum bandwidth threshold.

21. The non-transitory computer-readable storage medium of claim 16, wherein the transmission of media is based on a packet format that supports media for a plurality of media content types, and wherein a packet in the transmission of media includes a frame for each media content type associated with the plurality of media channels.

22. The system of claim 11, wherein the transmission of media is based on a packet format that supports media for a plurality of media content types, and wherein a packet in the transmission of media includes a frame for each media content type associated with the plurality of media channels.
